(19) United States
(12) Patent Application Publication
(10) Pub. No.: US 2005/0229791 A1
(43) Pub. Date: Oct. 20, 2005

(54) Cooking container for preventing an overflow condition

(76) Inventors: William J. Wanatosky, Olney, MD (US); Grant K. Rowan, Bethesda, MD (US)

Correspondence Address: SUGHRUE MION, PLLC, 2100 PENNSYLVANIA AVENUE, N.W., SUITE 800, WASHINGTON, DC, 20037, US

(21) Appl. No.: 10/827,342

(22) Filed: Apr. 20, 2004

(51) Int. Cl. A47J 37/12

(52) U.S. Cl. 99/403

(57) ABSTRACT

A container apparatus is provided that has an inner container and an outer container. The inner container has a first upper edge and holds a substance in a first space inside the inner container. The outer container is coupled to the inner container, and a second space is defined between the inner container and the outer container. When the substance flows out of the first space inside the inner container and over the first upper edge, the substance is received in the second space.

### FIELD OF THE INVENTION

An illustrative, non-limiting embodiment of the invention relates to a cooking container. A more specific, non-limiting embodiment relates to a cooking container that prevents liquid contained in the container from overflowing out of the container in an undesirable manner.

### BACKGROUND OF THE INVENTION

Many different types of cooking containers have been used to cook many different types of food. For example, FIG. 1 shows a perspective view of a hypothetical cooking container 100 that is used outdoors and that is designed to “deep fry” various foods, such as a turkey. As shown in the figure, the container 100 rests upon a stand 102, and a heating source (i.e. a fire 104) is provided underneath the stand 102 to heat the container 100. In the present example, the fire 104 is fueled by a flammable gas (e.g. propane), and the gas is supplied from a tank 108 to an area underneath the stand 102 via a tube 106.

FIGS. 2A to 2C are cross-sectional views of the cooking container 100 shown in FIG. 1. As shown in the figures, a turkey 206 can be deep fried in the container 100 by filling the container 100 with cooking oil 200. Also, a user's manual may be provided with the container 100 to inform a user how to properly cook the turkey 206 with the container 100. For example, the user's manual may contain various cooking conditions and specifications that must be followed in order to prevent the oil 200 from flowing over the rim 204 of the cooking container 100 during a cooking operation. In one scenario, the user's manual may state that, when the container 100 is initially filled with cooking oil 200, the cooking oil 200 should not be filled higher than a predetermined maximum level 202. Also, the user's manual may state that the cooking container 100 should only be used to cook turkeys that weigh less than a predetermined maximum weight.

Assuming that a user abides by the conditions and specifications provided in the user's manual, the turkey 206 is deep fried in the container 100 in the following manner. First, as shown in FIG. 2A, the user fills the cooking container 100 with cooking oil 200 such that the oil 200 does not exceed the predetermined maximum level 202. Then, as shown in FIG. 2B, the user begins to submerge the turkey 206 into the cooking container 100. As the turkey 206 is being submerged, the oil 200 rises up the side of the container 100 towards the rim 204. Subsequently, as shown in FIG. 2C, the turkey 206 is fully submerged in the oil 200 and is cooked.

Since the user followed the cooking conditions and specifications, the turkey 206 weighs less than the maximum weight, and the container 100 is not filled with too much cooking oil 200. Accordingly, when the turkey 206 is fully submerged in the oil 200 (as shown in FIG. 2C), the oil 200 does not flow over the rim 204 of the container 100 during the cooking process.

On the other hand, if a user attempts to cook a turkey that weighs too much and/or fills the container 100 with too much cooking oil 200, a strong possibility exists that the oil 200 will overflow from the container 100 when the turkey is being cooked. FIGS. 3A to 3C show an example in which a user (1) attempts to cook a turkey 306 that weighs too much and (2) fills the container 100 with too much oil 200.

As shown in FIG. 3A, the cooking oil 200 is filled above the predetermined maximum level 202. Then, as the user begins to submerge the turkey 306 into the oil 200, the oil 200 rises up the side of the container 100 towards the rim 204 as shown in FIG. 3B. Subsequently, as shown in FIG. 3C, when the turkey 306 is fully submerged, the oil 200 rises up and over the rim 204 of the container 100 and flows down the side 208 of the container 100.

When the cooking oil 200 overflows from the container 100, extremely dangerous conditions arise. For example, during the cooking operation, the oil 200 becomes very hot. Thus, if a person is standing near the container 100 when the oil 200 overflows, he or she could be severely scalded and burned. In addition, in many cooking scenarios, the oil 200 is flammable. Thus, after the oil 200 flows down the side 208 of the container 100, it travels past the bottom edge 210 of the container 100 towards the fire 104 and ignites. When the oil 200 ignites, it causes the fire 104 to erupt with large flames, and people and things located near the container 100 will be severely burned. Also, if the eruption of flames reaches the tank 108 containing the flammable gas, a large explosion may occur and cause even more devastating damage.

The inventors of the present application are not aware of any outdoor, deep-frying containers that have been tested and approved by Underwriters Laboratories, Inc. One possible reason why none of the containers has been approved may be due to the above-described and other inherent dangers of the containers.

FIG. 4 shows another example of a hypothetical cooking container 400 that is used indoors and that can cook various foods, such as pasta. As shown in the figure, the container 400 is placed on a burner 402 of a stove 404, and the burner 402 supplies heat to the container 400 to cook the pasta.

FIGS. 5A to 5D are cross-sectional views of the cooking container 400 shown in FIG. 4. As shown in the figures, pasta 506 can be cooked in the container 500 by filling the container 400 with water 500 and heating the water 500 by turning on the burner 402. When the water 500 comes to a boil, the pasta 506 is added to the water 500 as shown in FIG. 5B. Typically, as shown in FIG. 5C, when the pasta 506 is boiled in the water 500, foam 508 is generated at the surface of the water 500. As the water 500 continues to be heated and the pasta 506 continues to cook, the amount of foam 508 increases, and the foam 508 flows over the rim 504 and down the side 510 of the container 400 as shown in FIG. 5D.

After the foam 508 travels down the side 510 of the container 400, it contacts the burner 402 of the stove 404. If the burner 402 is an electric burner 402, the foam 508 is charred and fused to the burner 402 and other parts of the stove 404 and creates an unsightly mess. Moreover, cleaning the charred foam 508 from the burner 402 and stove 404 is difficult and time consuming. On the other hand, if the burner 402 is a gas burner 402, the foam 508 may extinguish or otherwise interrupt the flame of the burner 402 and thus, adversely affect the cooking of the pasta 506. Moreover, as in the case of an electrical burner 402, the foam 408 may become charred and fused to various parts of the stove 404. As a result, an unsightly mess is created which is difficult to clean.

### SUMMARY OF ILLUSTRATIVE, NON-LIMITING EMBODIMENTS OF THE INVENTION

Some illustrative, non-limiting embodiments of the present invention overcome the above disadvantages associated with cooking containers and other disadvantages. Also, the present invention is not required to overcome the above or other disadvantages, and an illustrative, non-limiting embodiment of the present invention may not overcome any disadvantages.

One illustrative, non-limiting embodiment of the present invention relates to a container apparatus that is provided with an inner container and an outer container. The inner container has a first upper edge and holds a substance in a first space inside the inner container. The outer container is coupled to the inner container, and a second space is defined between the inner container and the outer container. When the substance flows out of the first space inside the inner container and over the first upper edge, the substance is held in the second space by the outer container.

### BRIEF DESCRIPTION OF THE DRAWINGS

Aspects of illustrative, non-limiting embodiments of the present invention will become more apparent by describing in detail embodiments thereof with reference to the attached drawings in which:

FIG. 1 illustrates a perspective view of a cooking container that is used to deep fry food;

FIG. 2A illustrates a cross-sectional view of the cooking container shown in FIG. 1 during a first stage of a first cooking operation;

FIG. 2B illustrates a cross-sectional view of the cooking container shown in FIG. 1 during a second stage of the first cooking operation;

FIG. 2C illustrates a cross-sectional view of the cooking container shown in FIG. 1 during a third stage of the first cooking operation;

FIG. 3A illustrates a cross-sectional view of the cooking container shown in FIG. 1 during a first stage of a second cooking operation;

FIG. 3B illustrates a cross-sectional view of the cooking container shown in FIG. 1 during a second stage of the second cooking operation;

FIG. 3C illustrates a cross-sectional view of the cooking container shown in FIG. 1 during a third stage of the second cooking operation;

FIG. 4 illustrates a perspective view of a cooking container that is used to cook food on a stove;

FIG. 5A illustrates a cross-sectional view of the cooking container shown in FIG. 4 during a first stage of a third cooking operation;

FIG. 5B illustrates a cross-sectional view of the cooking container shown in FIG. 4 during a second stage of the third cooking operation;

FIG. 5C illustrates a cross-sectional view of the cooking container shown in FIG. 4 during a third stage of the third cooking operation;

FIG. 5D illustrates a cross-sectional view of the cooking container shown in FIG. 4 during a fourth stage of the third cooking operation;

FIG. 6 illustrates a perspective view of a cooking container in accordance with a first illustrative, non-limiting embodiment of the present invention.

FIG. 7A illustrates a non-limiting example of the cross-sectional shapes of an inner container and an outer container of the container shown in FIG. 6;

FIG. 7B illustrates a non-limiting example of alternative cross-sectional shapes of the inner container and the outer container of the container shown in FIG. 6;

FIG. 7C illustrates a non-limiting example of other alternative cross-sectional shapes of the inner container and the outer container of the container shown in FIG. 6;

FIG. 8A illustrates a cross-sectional view of the cooking container shown in FIG. 6 during a first stage of an exemplary fourth cooking operation;

FIG. 8B illustrates a cross-sectional view of the cooking container shown in FIG. 6 during a second stage of the exemplary fourth cooking operation;

FIG. 8C illustrates a cross-sectional view of the cooking container shown in FIG. 6 during a third stage of the exemplary fourth cooking operation;

FIG. 8D illustrates a cross-sectional view of the cooking container shown in FIG. 6 during a fourth stage of the exemplary fourth cooking operation;

FIG. 9A illustrates a non-limiting example of the container shown in FIG. 6 in which the inner rim and the outer rim have a first, non-limiting, alternative structural orientation;

FIG. 9B illustrates a non-limiting example of the container shown in FIG. 6 in which the inner rim and the outer rim have a second, non-limiting, alternative structural orientation;

FIG. 10A illustrates a non-limiting example of the container shown in FIG. 6 in which the inner container and the outer container have a non-limiting, alternative structural orientation;

FIG. 10B is a top view of the container in accordance with the illustrative, non-limiting example shown in FIG. 10A;

FIG. 10C illustrates a non-limiting example of the container shown in FIG. 6 in which the inner container and the outer container have another non-limiting, alternative structural orientation;

FIG. 10D illustrates a non-limiting example of the container shown in FIG. 6 in which the inner container and the outer container have yet another non-limiting, alternative structural orientation;

FIG. 10E is a top view of the container in accordance with the illustrative, non-limiting example shown in FIG. 10D;

FIG. 11A illustrates a cross-sectional view of a cooking container in accordance with a second illustrative, non-limiting embodiment of the present invention during a first stage of an exemplary fifth cooking operation;

FIG. 11B illustrates the cooking container shown in FIG. 11A during a second stage of the exemplary fifth cooking operation;

FIG. 11C illustrates the cooking container shown in FIG. 11A during a third stage of the exemplary fifth cooking operation;

FIG. 11D illustrates a cross-sectional view of a cooking container in accordance with a third illustrative, non-limiting embodiment of the present invention;

FIG. 12 illustrates a cross-sectional view of a cooking container in accordance with a fourth illustrative, non-limiting embodiment of the present invention;

FIG. 13 illustrates a cooking container in accordance with a fifth illustrative, non-limiting embodiment of the present invention;

FIG. 14A illustrates a cross-sectional view of the cooking container shown in FIG. 13 during a first stage of an exemplary sixth cooking operation;

FIG. 14B illustrates a cross-sectional view of the cooking container shown in FIG. 13 during a second stage of the exemplary sixth cooking operation;

FIG. 14C illustrates a cross-sectional view of the cooking container shown in FIG. 13 during a third stage of the exemplary sixth cooking operation;

FIG. 14D illustrates a cross-sectional view of the cooking container shown in FIG. 13 during a fourth stage of the exemplary sixth cooking operation;

FIG. 14E illustrates a cross-sectional view of the cooking container shown in FIG. 13 during a fifth stage of the exemplary sixth cooking operation;

FIG. 15 illustrates a cooking container in accordance with a sixth illustrative, non-limiting embodiment of the present invention; and

FIG. 16 illustrates a cooking container in accordance with a seventh illustrative, non-limiting embodiment of the present invention.

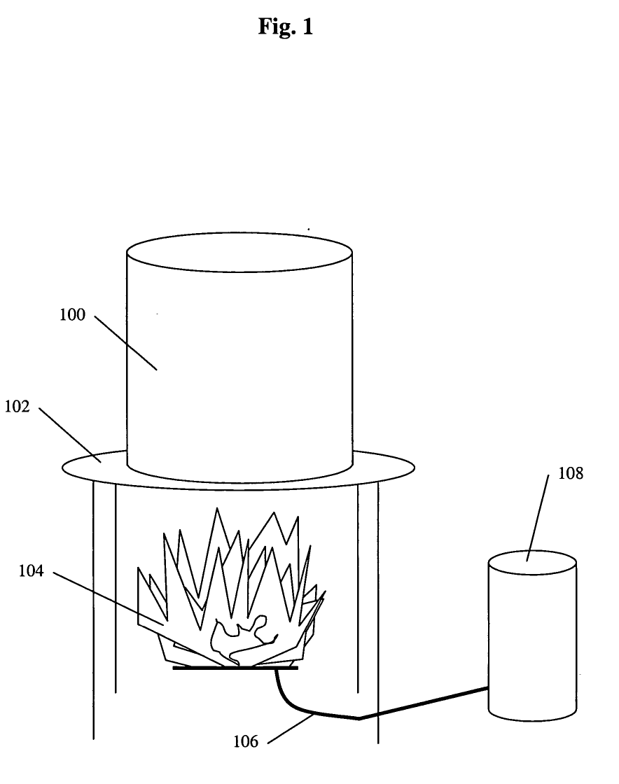

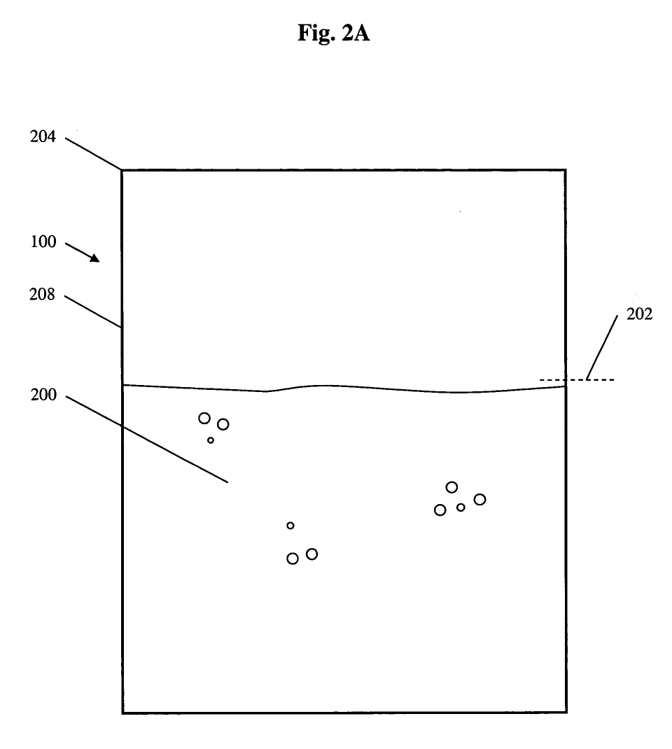

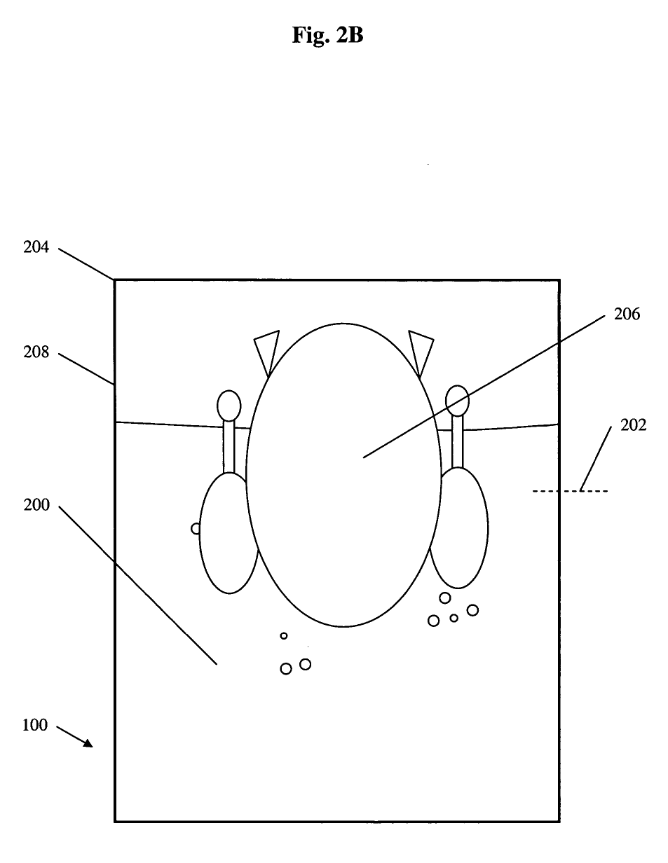

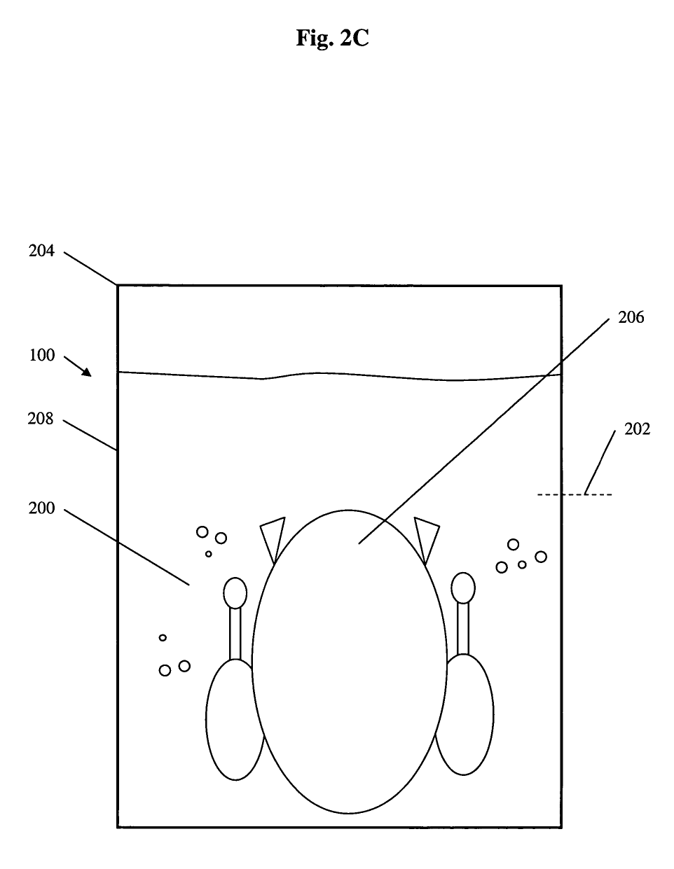

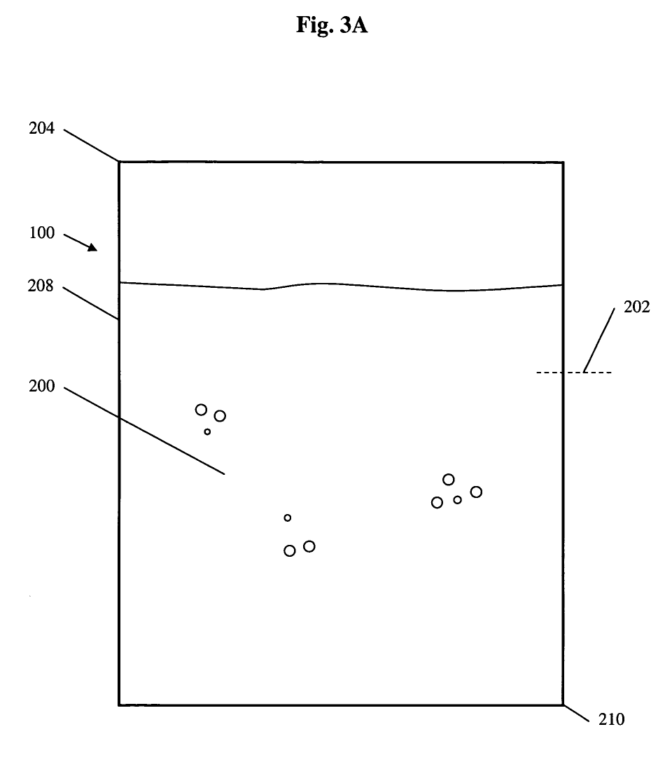

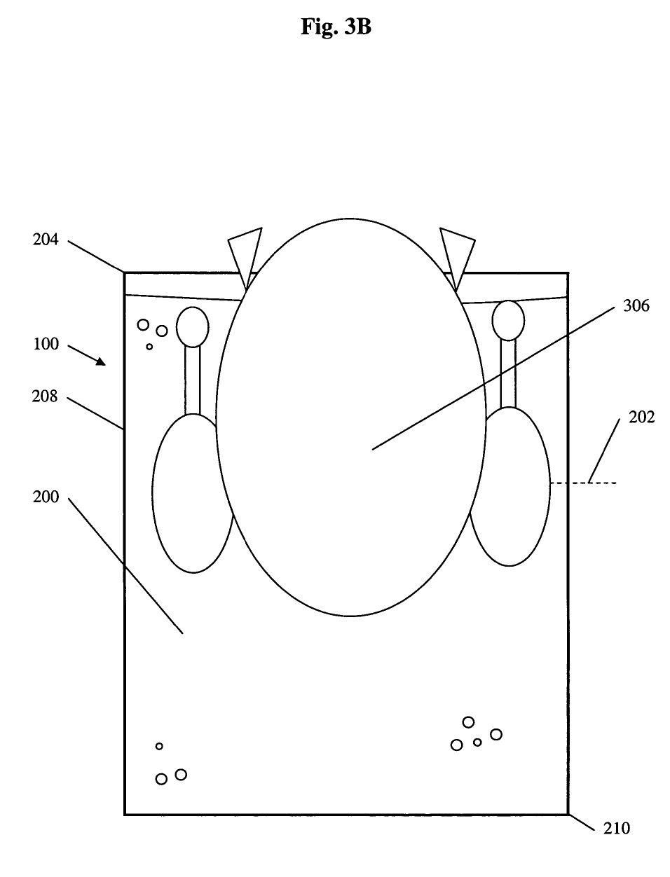

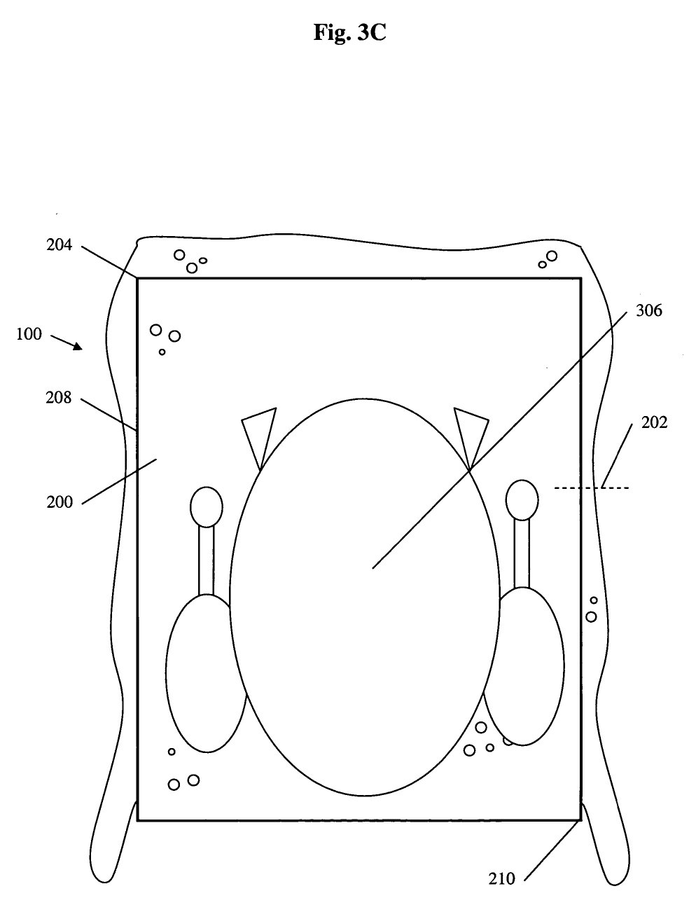

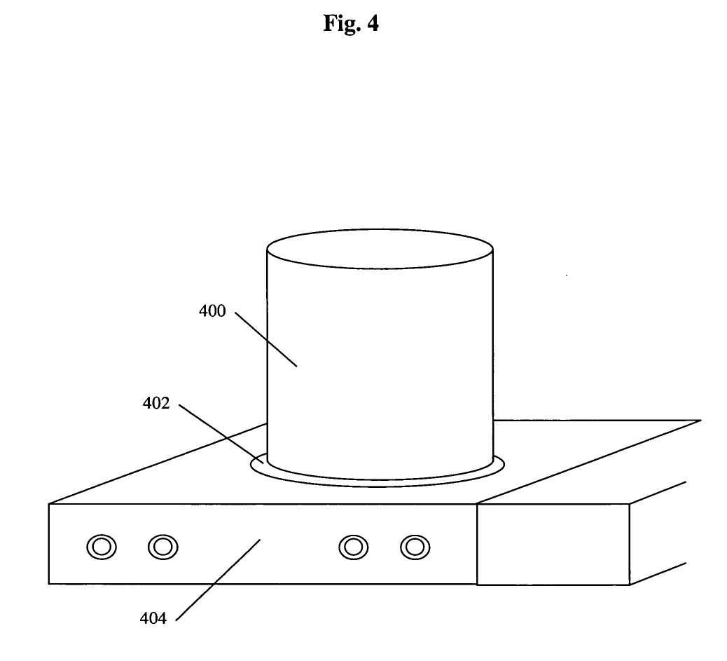

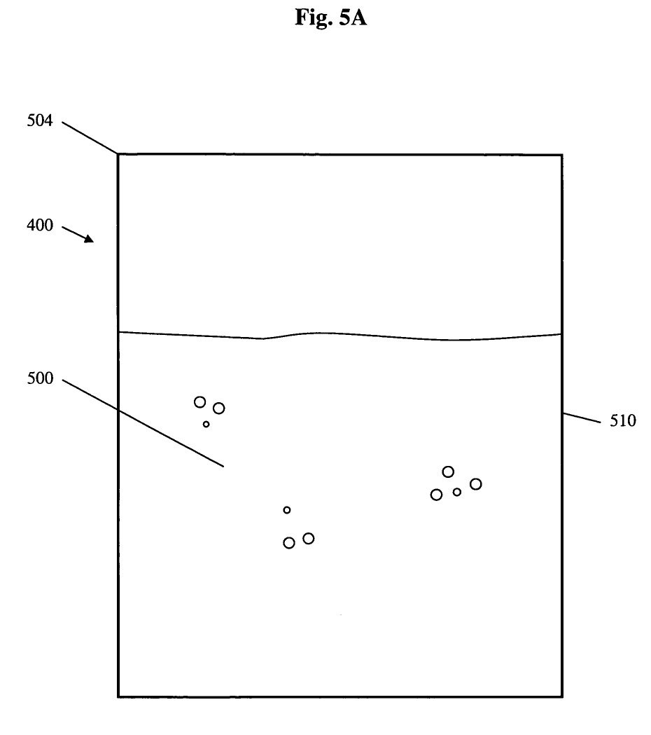

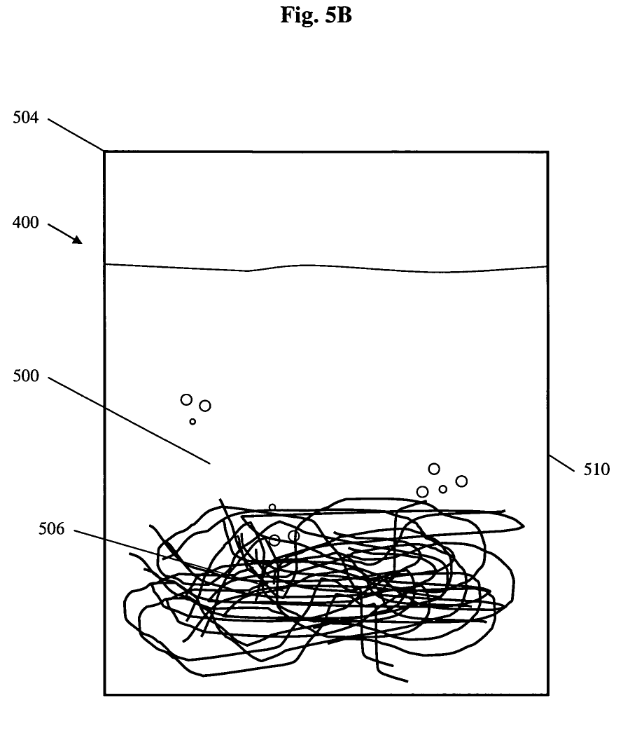

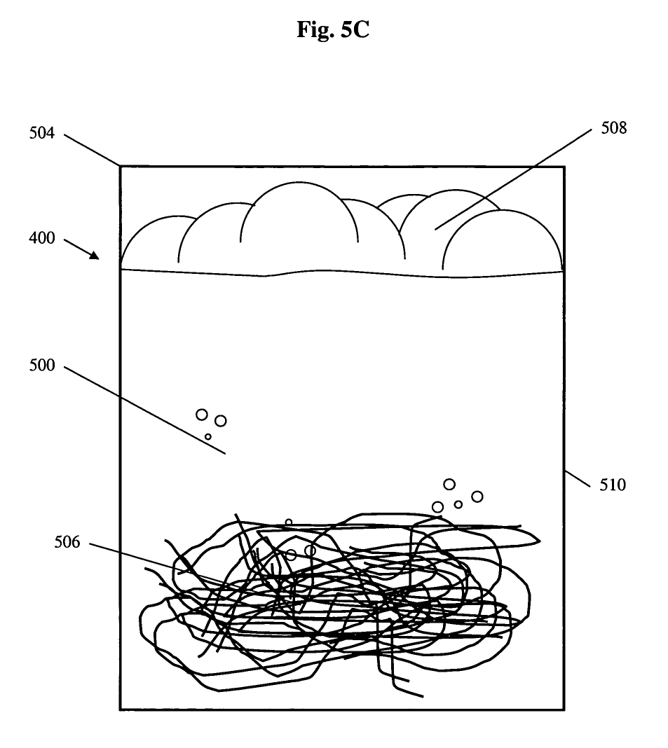

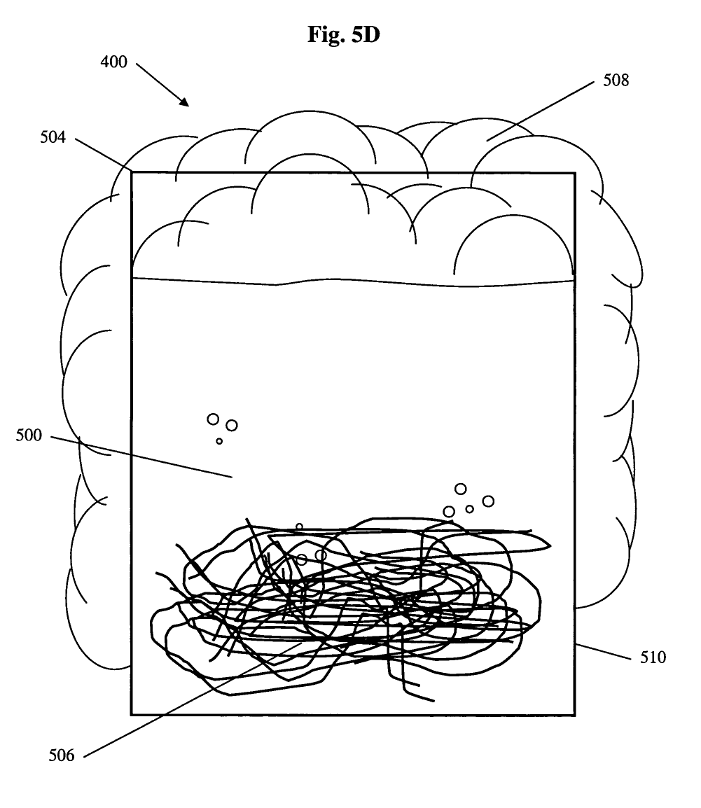

### DESCRIPTION OF ILLUSTRATIVE NON-LIMITING EMBODIMENTS OF THE INVENTION

The following description of illustrative, non-limiting embodiments of the invention discloses specific configurations and components. However, the embodiments are merely examples of the present invention, and thus, the specific features described below are merely used to more easily describe such embodiments and to provide an overall understanding of the present invention. Furthermore, the descriptions of various configurations and components of the embodiments that are known to one skilled in the art are omitted for the sake of clarity and brevity.

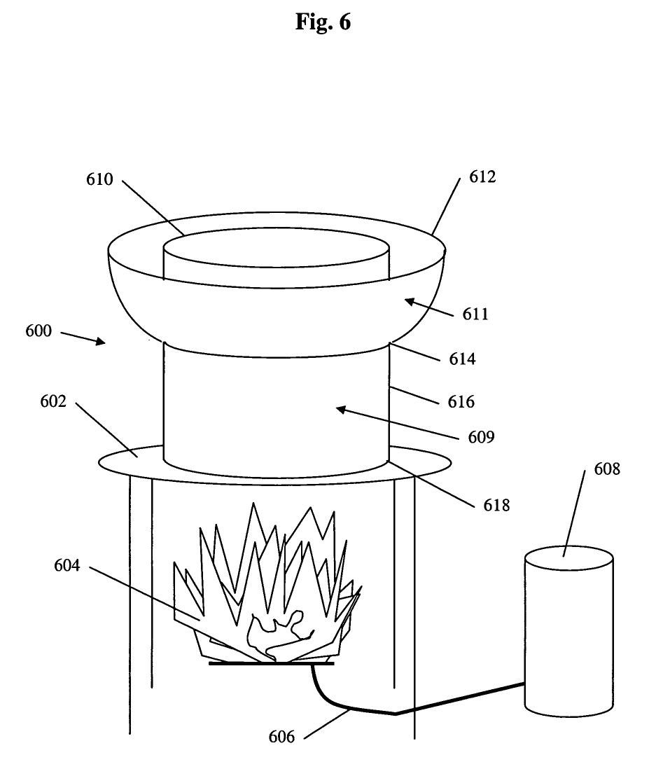

FIG. 6 shows a perspective view of a cooking container 600 in accordance with an illustrative, non-limiting embodiment of the present invention. In one implementation, the container 600 is used outdoors and is designed to “deep fry” various foods, such as a turkey. As shown in the figure, the container 600 rests upon a stand 602, and a heating source (e.g. a fire 604) is provided underneath the stand 602 to heat the container 600. Also, a flammable gas (e.g. propane) fuels the fire 604, and the gas is supplied from a tank 608 to an area underneath the stand 602 via a tube 606.

The container 600 comprises an inner container 609 and an outer container 611. The inner container 609 comprises an inner rim 610, and the outer container 611 comprises an outer rim 612. Furthermore, a bottom edge 614 of the outer container 611 is connected to an outer side surface 616 of the inner container 609 at a point between the inner rim 610 and a bottom edge 618 of the inner container 609.

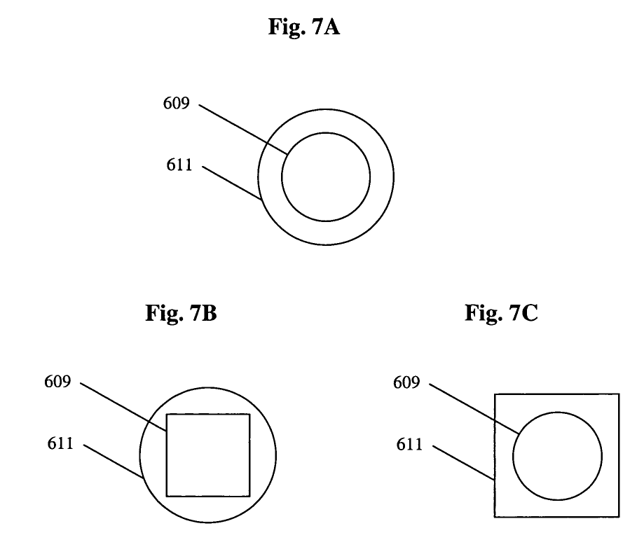

In the present embodiment, the shape of the inner container 609 is cylindrical, and the shape of the outer container 611 is “bowl-shaped”. However, the present invention clearly is not limited to the specific shapes of the containers 609 and 611, and virtually any shaped containers 609 and 611 may be used without departing from the spirit of the invention. For example, the cross-sectional shapes of the inner container 609 and the outer container 611 (as viewed from above) are circular, as shown in FIG. 7A. However, the cross-sectional shape of the containers 609 and 611 may be different. For instance (and not by way of limitation), the cross-sectional shape of the inner container 609 may be square shaped, and the cross-sectional shape of the outer container 611 may be circular as shown in FIG. 7B. As another non-limiting example, the cross-sectional shape of the inner container 609 may be circular, and the cross-sectional shape of the outer container 611 may be square shaped as shown in FIG. 7C.

Needless to say, upon reading the specification, one skilled in the art will readily understand that that the cross-sectional shapes of the containers 609 and 611 can be the same or different and can take the form of any regular or irregular geometric shape. Moreover, one skilled in the art will similarly recognize that other cross-sections, dimensions, and features of the containers 609 and 611 can have virtually any shape and size.

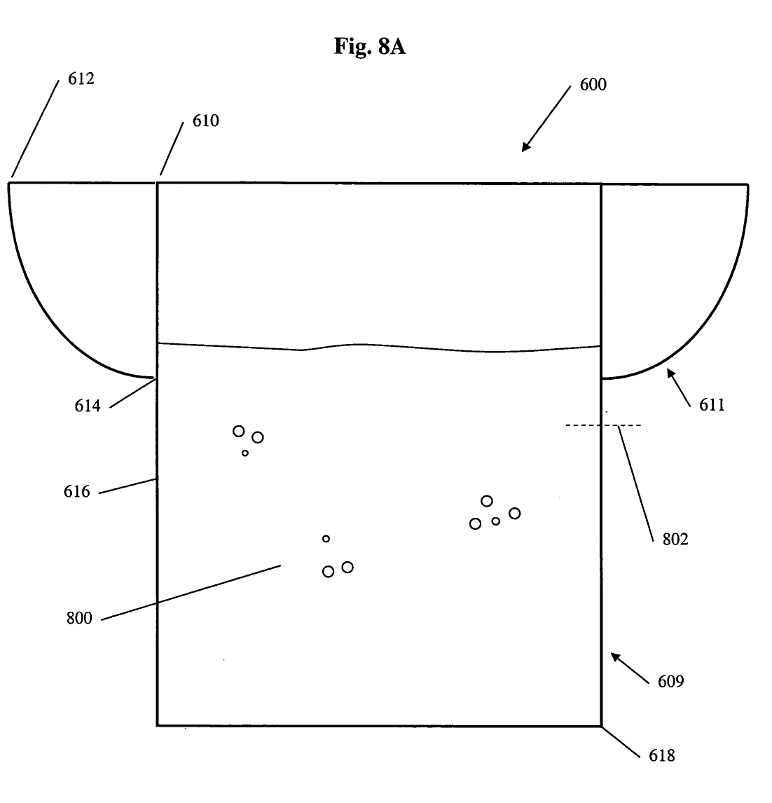

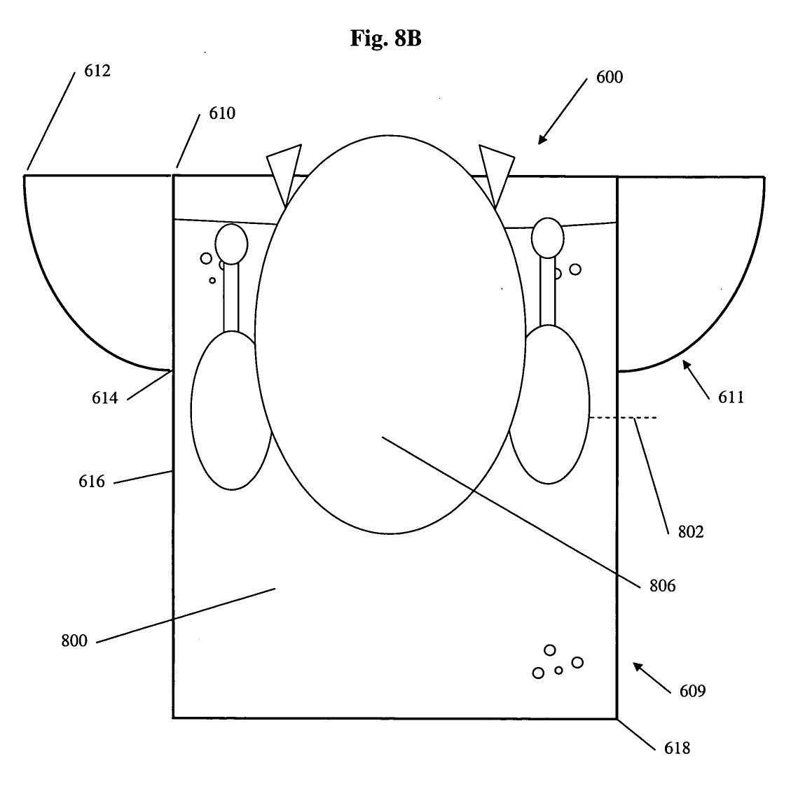

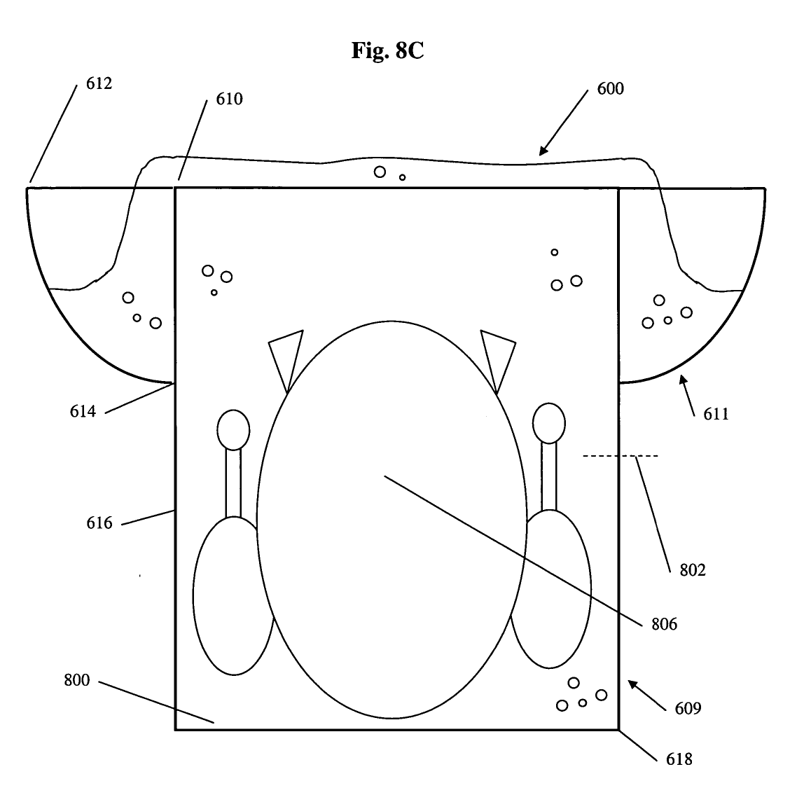

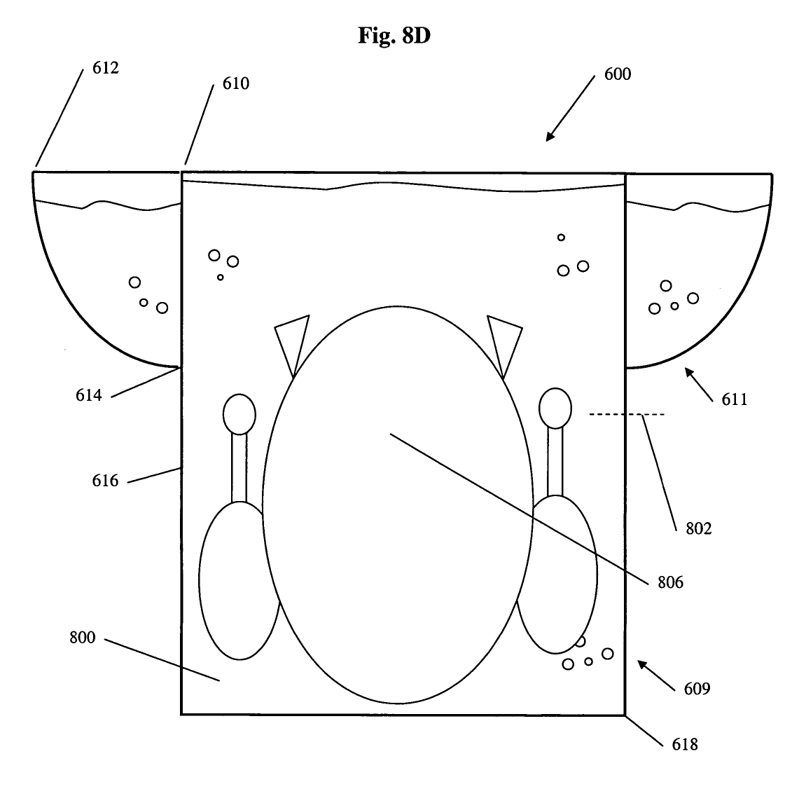

FIGS. 8A to 8D are cross-sectional views of the cooking container 600 shown in FIG. 6 and illustrate a situation in which a user attempts to use the container 600 to cook a turkey 806 that weighs too much and in which the user fills the container 600 with too much cooking oil 800. As shown in FIG. 8A, the cooking oil 800 is filled above a predetermined maximum level 802 (as noted in the manufacturer's cooking instructions). Then, as the user begins to submerge the turkey 806 into the oil 800, the oil 800 rises up the inner side of the inner container 609 towards the inner rim 610 as shown in FIG. 8B.

Subsequently, as shown in FIG. 8C, when the turkey 806 is fully submerged, the oil 800 rises up and over the inner rim 610 of the inner container 609 and flows into the outer container 611. FIG. 8D shows the cross-sectional view of the container 600 when the flow of cooking oil 800 from the inner container 609 to the outer container 611 reaches an equilibrium.

Since the outer container 611 is provided around the inner container 609, the oil 800 that flows over the inner rim 610 is prevented from travelling all of the way down the outer side surface 616 of the inner container 609. As a result, the overflowing oil 800 does not reach the fire 604 or people standing near the container 600, and potentially dangerous situations are avoided.

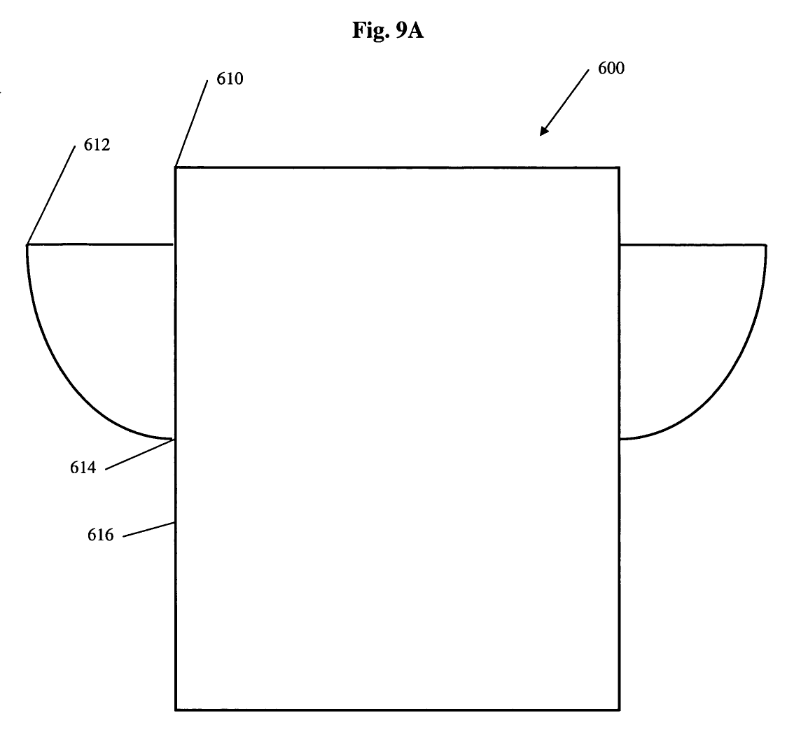

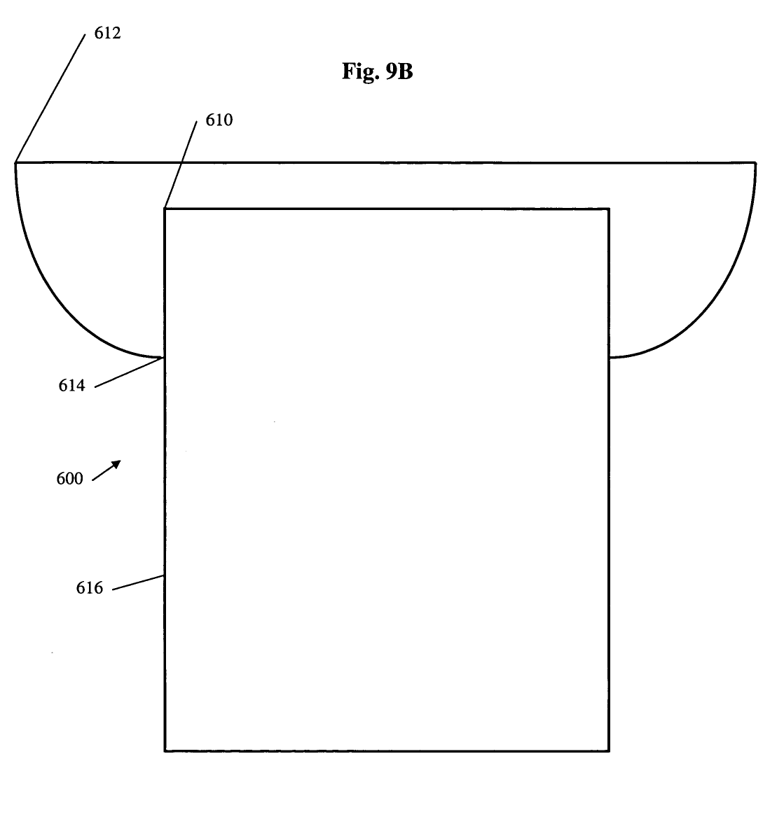

As shown in FIGS. 6 and 8A to 8D, the inner rim 610 of the inner container 609 and the outer rim 612 of the outer container 611 are at the same height and lie within the same plane. However, the present invention is clearly not limited to such an arrangement. For example (and not by way of limitation), the inner rim 610 could be located above the outer rim 612 as shown in FIG. 9A. Conversely, the inner rim 610 could be located below the outer rim 612 as shown in FIG. 9B.

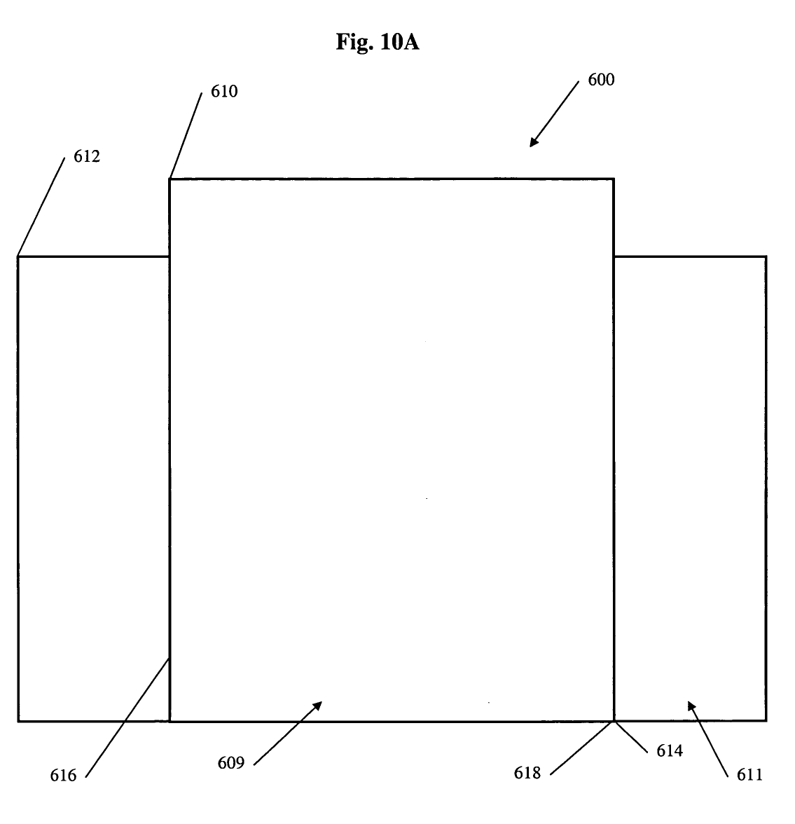

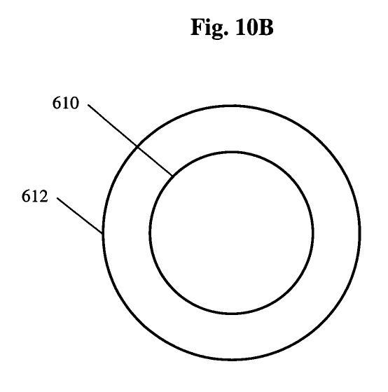

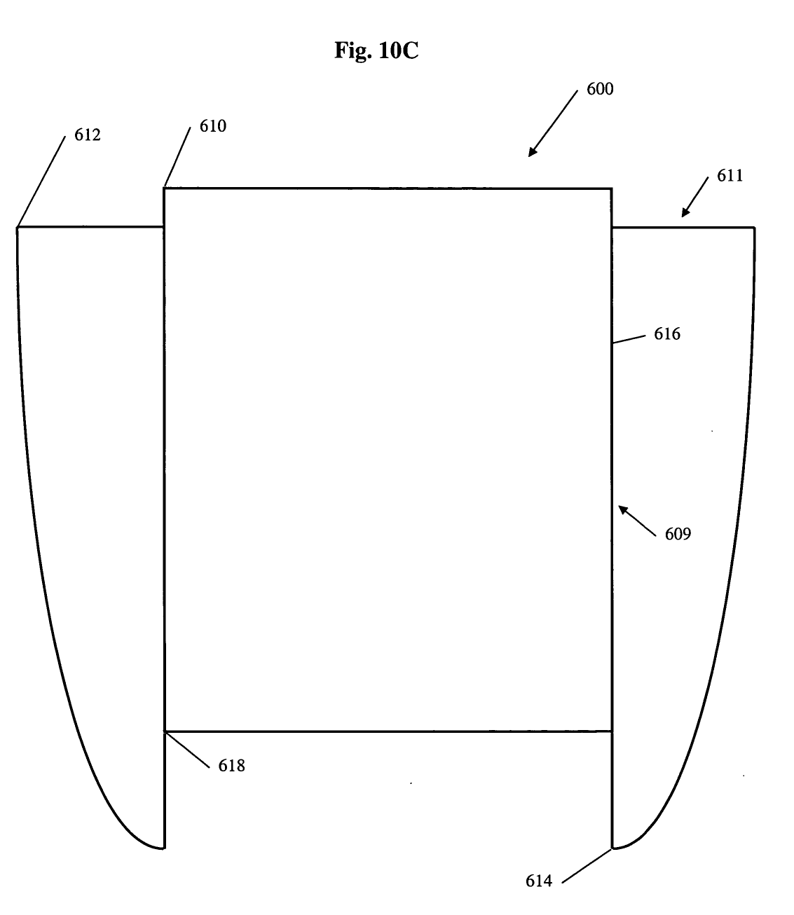

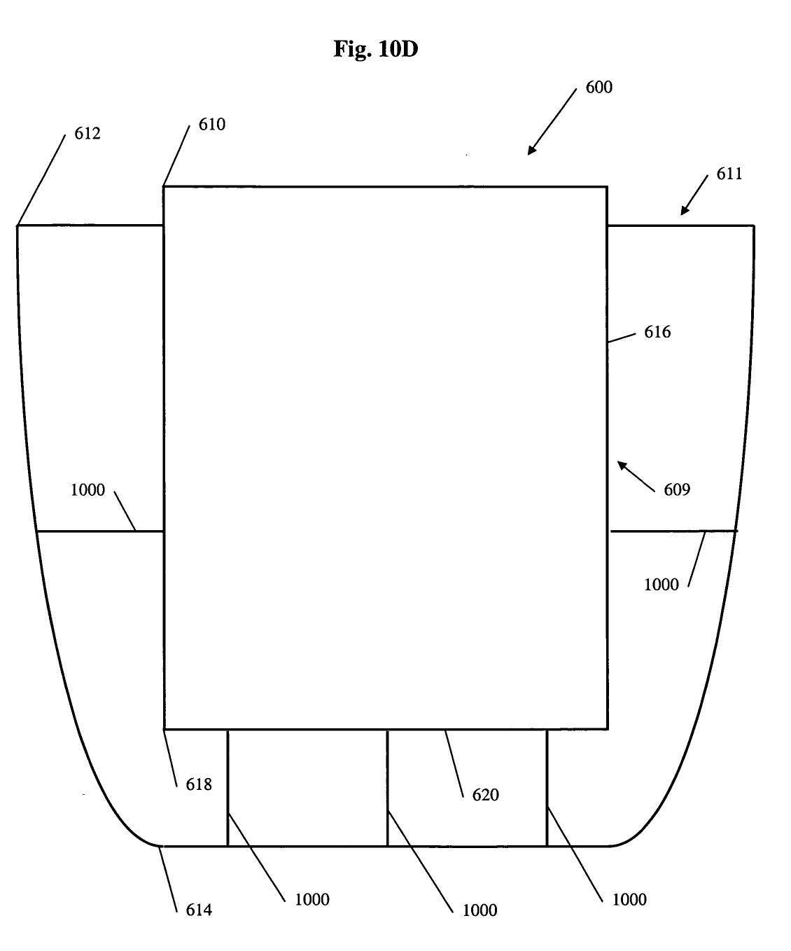

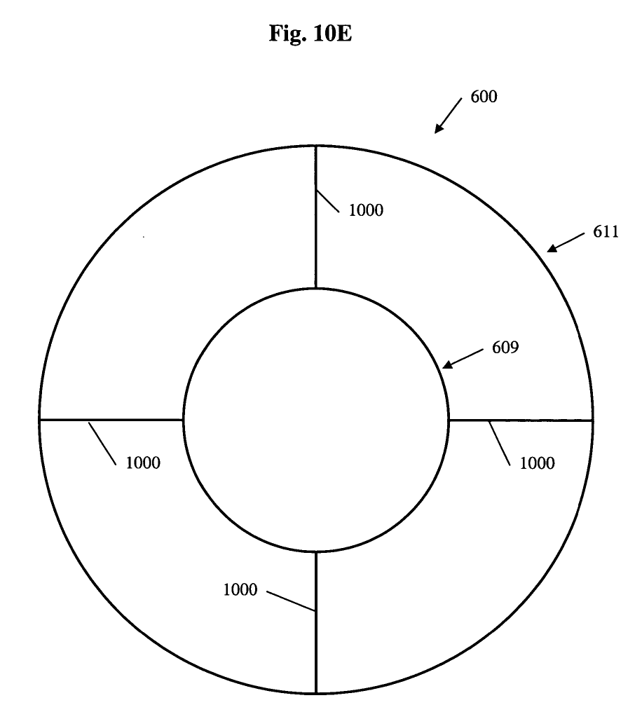

Also, as shown in FIGS. 6 and 8A to 8D, the bottom edge 614 of the outer container 611 is connected to the outer surface 616 of the inner container 609 at a point between the inner rim 610 and the bottom edge 618 of the inner container 610. Again, one skilled in the art will readily understand that the present invention is not limited to such structure. For instance, FIGS. 10A and 10B respectively illustrate a side cross-sectional view and top view of an illustrative, non-limiting embodiment in which the bottom edge 614 of the outer container 611 is connected to the bottom edge 618 of the inner container 610.

Furthermore, FIG. 10C shows a side cross-sectional view of a non-limiting example of a container 600 in which the bottom edge 614 of the outer container 611 is located below the bottom edge 618 of the inner container 609. As shown in the figure, the outer container 611 is connected to the inner container 609 at least at the bottom edge 618 of the inner container 609.

FIG. 10D shows another illustrative example of a container 600 in which the bottom edge 614 of the outer container 611 is located below the bottom edge 618 of the inner container 609. However, unlike the container shown in FIG. 10C, the outer container 611 is not connected to the bottom edge 618 of the inner container 609. Instead, the outer container 611 is connected to the inner container 609 via one or more supports 1000. The one or more supports 1000 may connect the outer container 611 to the outer side surface 616 of the inner container 609. Alternatively or additionally, the one or more supports 1000 may connect the outer container 611 to the outer bottom surface 620 of the inner container 609. Still alternatively or additionally, the one or more supports 1000 may connect the outer container 611 to the inner rim 610 of the inner container 609. Yet alternatively or additionally, the one or more supports 1000 may connect the outer container 611 to the bottom edge 618 of the inner container 609.

FIG. 10E is a top view of an illustrative, non-limiting example of the container 600 shown in FIG. 10D, in which a plurality of supports 1000 are formed around the inner container 609 in a “spoke-like” fashion. In one implementation, the supports 1000 may be spaced around the inner container 609 such that the distance between each of the supports 1000 is the same. Of course, the spacing between adjacent supports 1000 does not need to be uniform.

Moreover, in the embodiment shown in FIGS. 10A and 10B, the outer container 611 is not bowl shaped (as in FIGS. 6 and 8A to 8D), but is instead, cylindrically shaped. However, as mentioned above, the outer container 611 could be bowl shaped or any other shape, and the inner container 609 could have a shape other than cylindrical. Similarly, the shapes of the inner and outer containers 609 and 611 shown in FIGS. 10C to 10E are not limited, and one skilled in the art, upon reading the present specification, will readily realize that the containers 609 and 611 can have many different shapes and sizes.

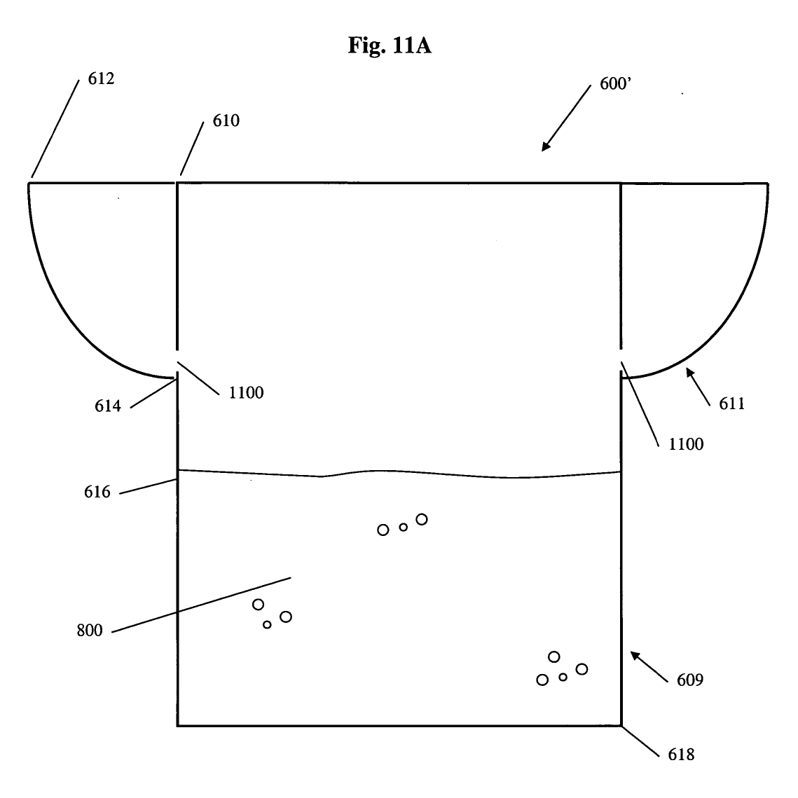

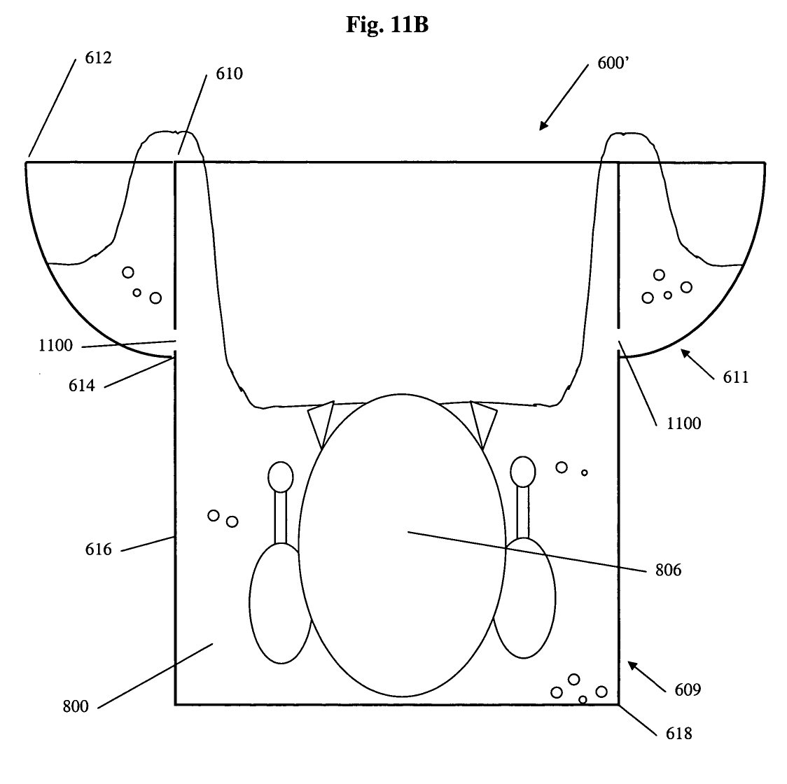

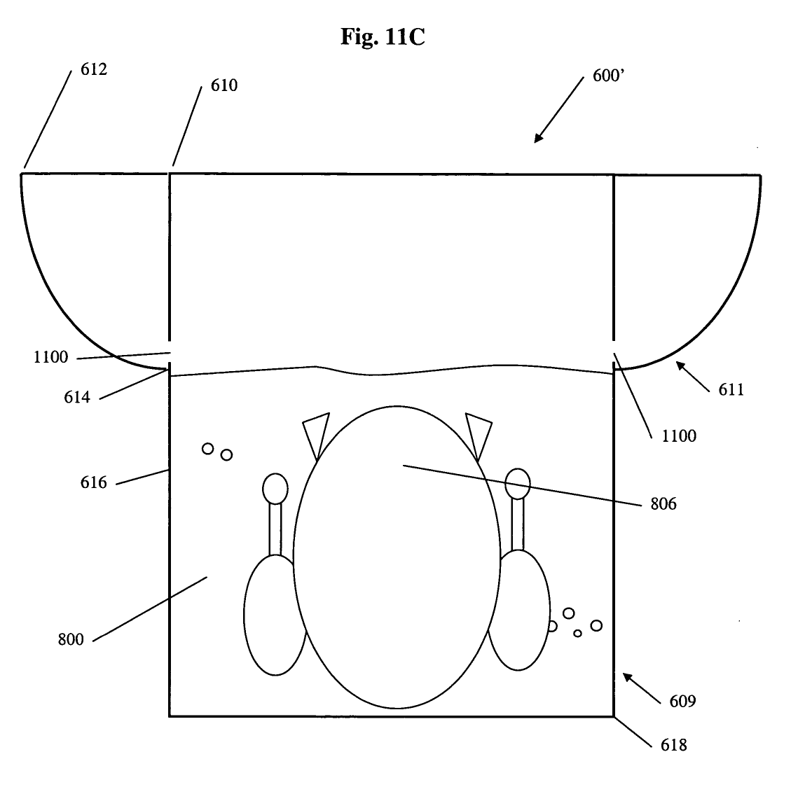

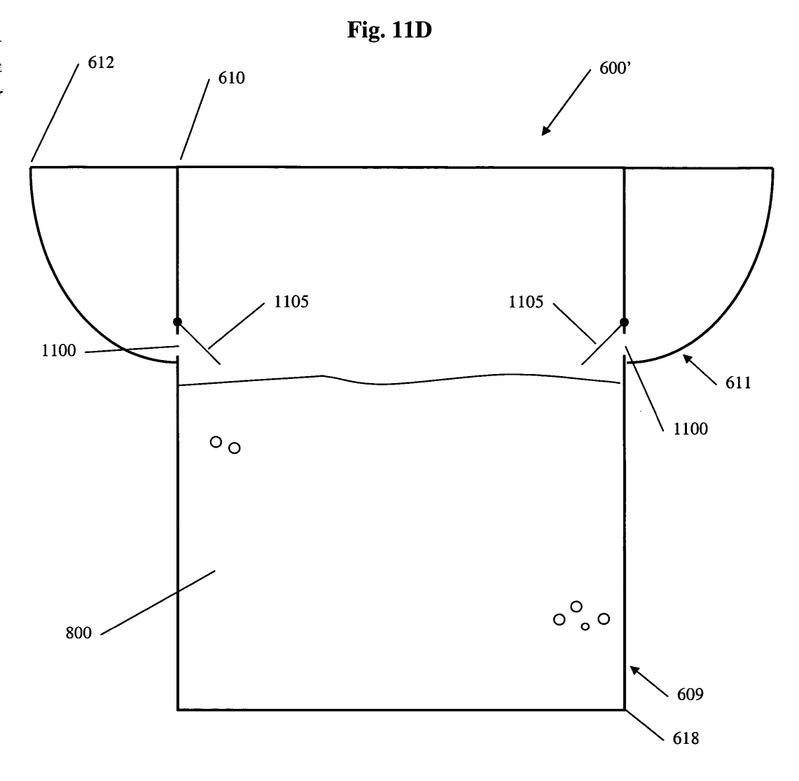

FIG. 11A shows a cross-sectional view of a non-limiting embodiment of a cooking container 600′ in FIG. 6, which is similar to the container 600 shown in FIG. 6. However, unlike the container 600, the container 600′ comprises an inner container 609 that has one or more holes 1100. The hole or holes 1100 are located in the side or sides of the inner container 609 and provide a fluid path from the interior of the outer container 611 to the interior of the inner container 609.

By using the container 600′ with the above construction, a constant amount of cooking oil 800 is maintained in the inner container 609 throughout the cooking process. For example, as shown in FIG. 11B, if a turkey 806 or other type of food is quickly submerged in the cooking oil 800, the oil 800 may splash upwardly and temporarily rise above the rim 610 of the inner container 609. As a result, some of the oil 800 flows into the outer container 611. However, when the splash subsides, the oil 800, which flowed into the outer container 611, flows back into the inner container 609 via the hole or holes 1100. Thus, after the oil 800 reaches equilibrium, all of the oil 800 is located in the inner container 609, as shown in FIG. 11C.

In the above embodiment, the hole or holes 1100 are provided in the inner container 609, which is cylindrical, and create a fluid path between the container 609 and the outer container 611, which is “bowl-shaped”. However, the hole or holes 1100 can clearly be used with many other types of inner and outer containers 609 and 611 besides the containers 609 and 611 illustrated in FIGS. 11A to 11C. For example, the hole or holes 1100 may be used with virtually any shaped containers 609 and 611 and may be located at numerous positions on the inner container 609, as long as a fluid path is provided between the interiors of the containers 609 and 611.

In addition, a valve may be provided with the hole or holes 1100 to allow the oil 800 to travel from the outer container 611 to the inner container 609 and to prevent the oil 800 from traveling from the inner container 609 to the outer container 611. FIG. 11 shows an illustrative, non-limiting embodiment of valves 1105 that control the flow of oil 800 between the containers 609 and 611. As shown in the figure, the valves 1105 are disposed within the interior of the inner container 609 and are pivotally connected to the inner container 609 at a position above the holes 1100. As the oil 800 flows from the outer container 611 to the inner container 609 via the holes 1100, the force of the flowing oil 800 pivots the valves 1105 away from the holes 1100 (to the positions shown in FIG. 11D), and the oil 800 is permitted to flow from the container 611 to the container 609. On the other hand, if the oil 800 attempts to flow from the inner container 609 to the outer container 611 via the holes 1100, the force of the flowing oil 800 pivots the valves 1105 toward the holes 1100 such that the valves 1105 cover the holes 1100. Accordingly, the flow of oil 800 from the container 609 to the container 611 is prevented or at least impeded to some degree.

Also, upon reading the present specification, one skilled in the art would readily realize that the present invention is not limited to the specific types of valves 1105 shown in FIG. 11D. For example, virtually any type of valve can be used that allows oil 800 to flow from the outer container 611 to the inner container 609 and that prevents or at least retards the flow of oil 800 from the inner container 609 to the outer container 611.

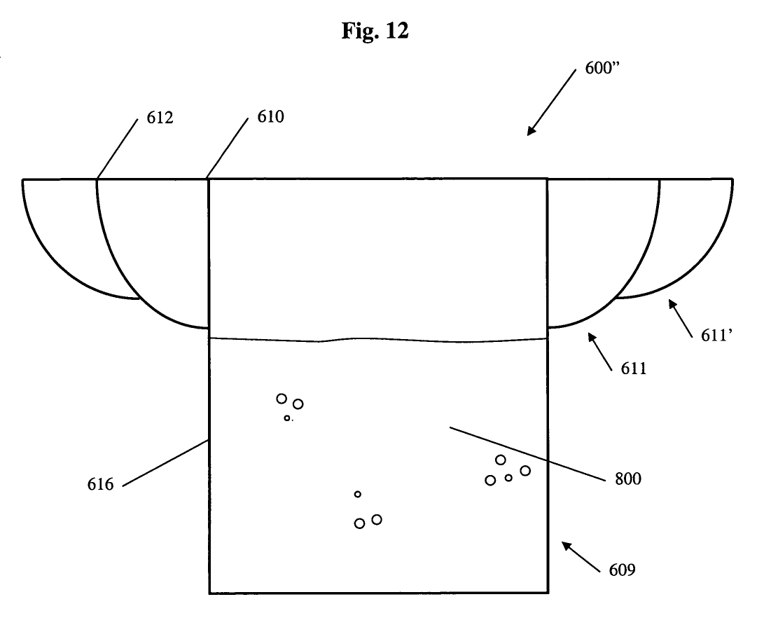

Also, although the embodiments described above have an inner container 609 and only one outer container 611, the present invention is not limited to such a configuration. For example, FIG. 12 shows an illustrative, non-limiting embodiment of a container 600′ that contains a first outer container 611 and a second outer container 611′. By using the second outer container 611′, the possibility of cooking oil 800 traveling all of the way down the outer side surface 616 of the inner container 609 is further reduced. Specifically, if an extremely large amount of oil 800 flows over the inner rim 610 of the inner container 609, the first outer container 611 may become full, and some oil 800 may flow over the outer rim 612 of the container 611. In such a scenario, the second outer container 611′ will catch the oil 800 flowing over the rim 612 and prevent such oil 800 from flowing all of the way down the side surface 616 of the inner container 609.

Furthermore, although two outer containers 611 and 611′ are shown in the above embodiment, a non-limiting embodiment of the invention may employ more than two outer containers. In addition, the specific structures and shapes of the containers 609, 611, and 611′ are not limited to those shown in FIG. 12, and upon reading the present specification, one skilled in the art would know how to use virtually any shaped containers 609, 611, and 611′.

Moreover, a hole or holes (not shown) may be provided between the interiors of the inner container 609 and the first outer container 611, as described above. Also, a hole or holes (not shown) additionally or alternatively may be provided between the interiors of the first outer container 611 and the second outer container 611′ in a similar manner.

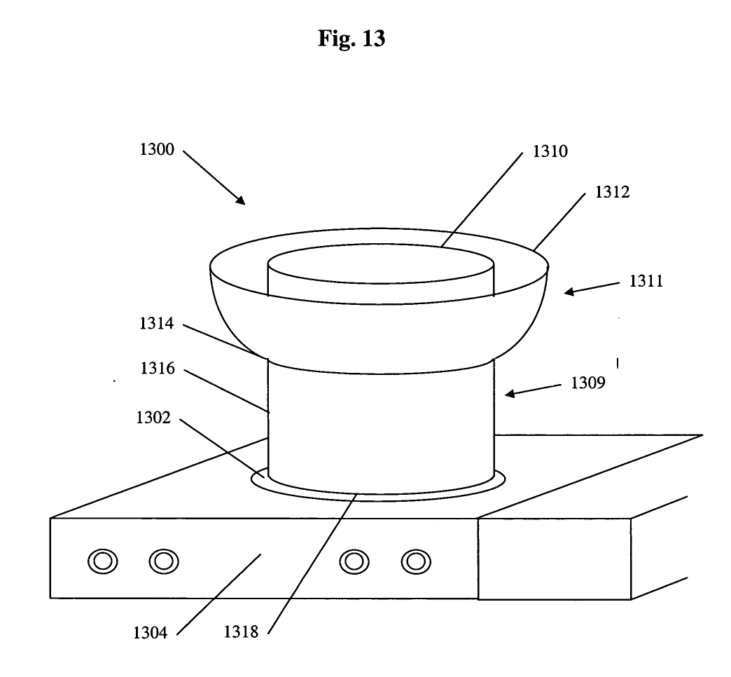

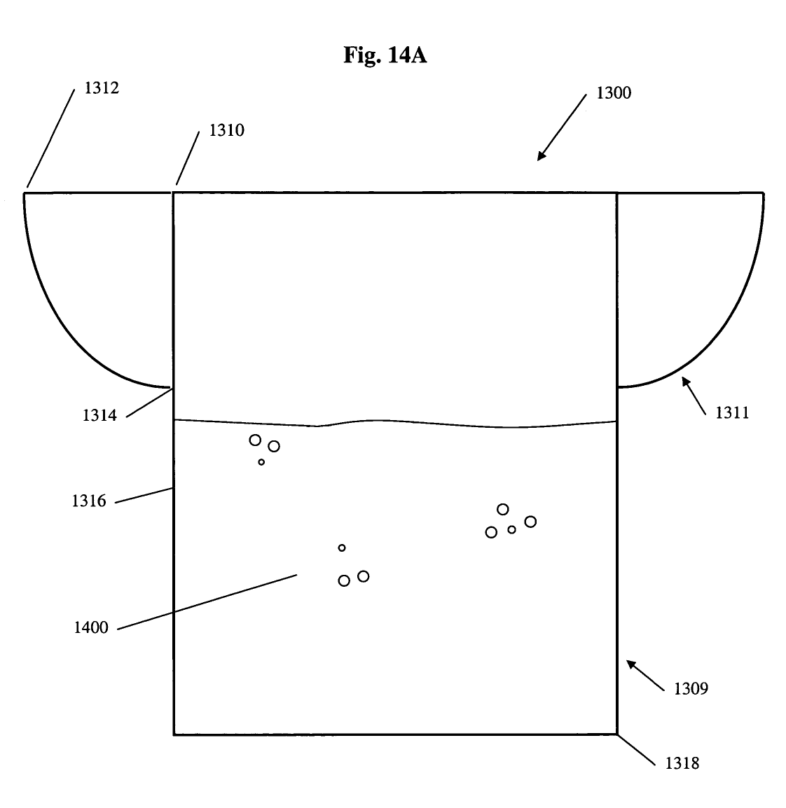

FIG. 13 shows another example of a cooking container 1300 that is used indoors and that can cook various foods, such as pasta. As shown in the figure, the container 1300 is placed on a burner 1302 of a stove 1304, and the burner 1302 supplies heat to the container 1300 to cook the pasta.

The container 1300 comprises an inner container 1309 and an outer container 1311. The inner container 1309 comprises an inner rim 1310, and the outer container 1311 comprises an outer rim 1312. Furthermore, a bottom edge 1314 of the outer container 1311 is connected to an outer side surface 1316 of the inner container 1309 at a point between the inner rim 1310 and a bottom edge 1318 of the inner container 1309.

In the present embodiment, the shape of the inner container 1309 is cylindrical, and the shape of the outer container 1311 is “bowl-shaped”. However, as described above in conjunction with the previous embodiments, the present invention clearly is not limited to the specific shapes and orientations of the containers 1309 and 1311, and virtually any shaped containers 1309 and 1311 may be used.

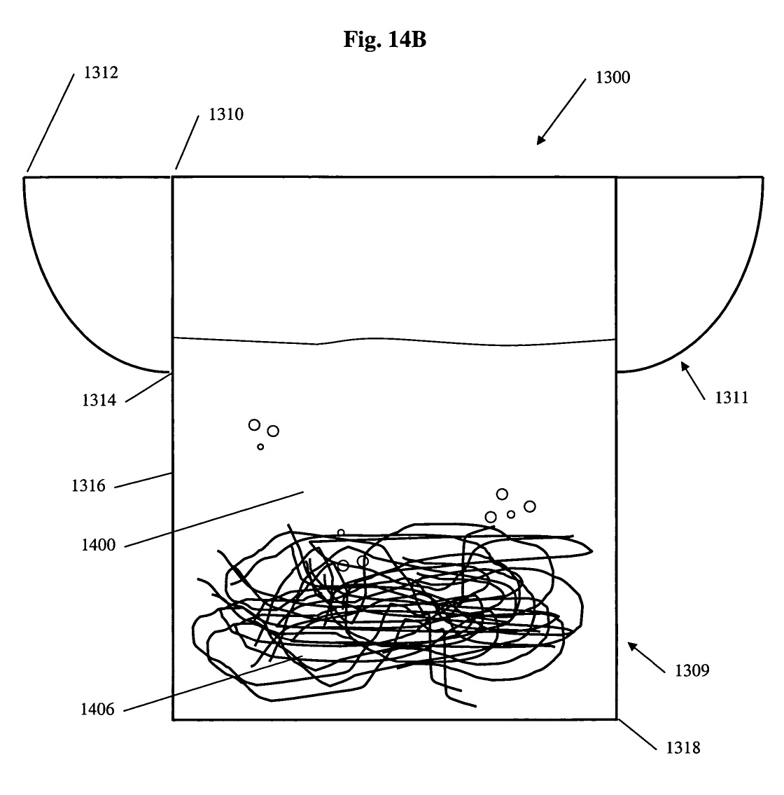

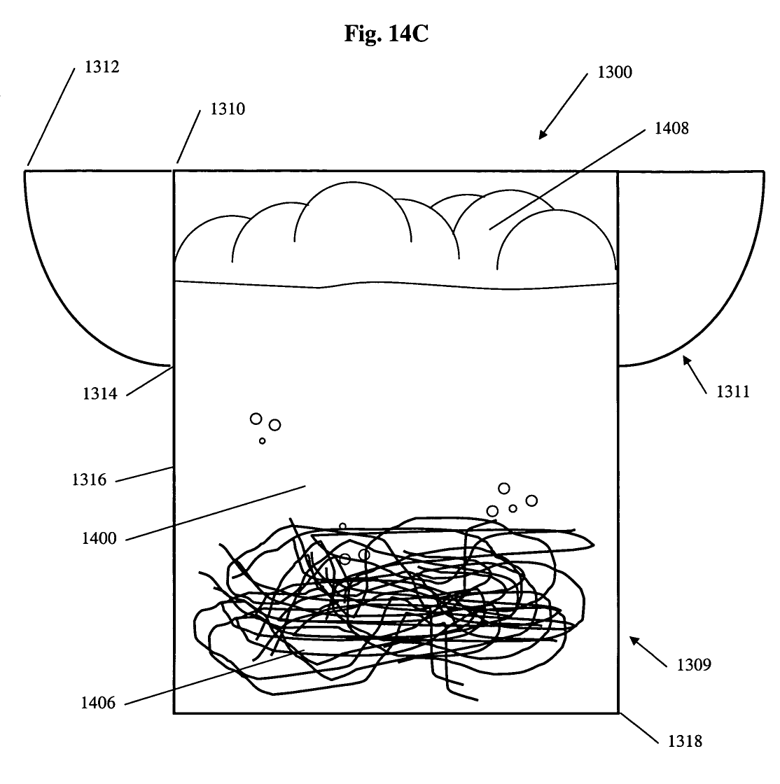

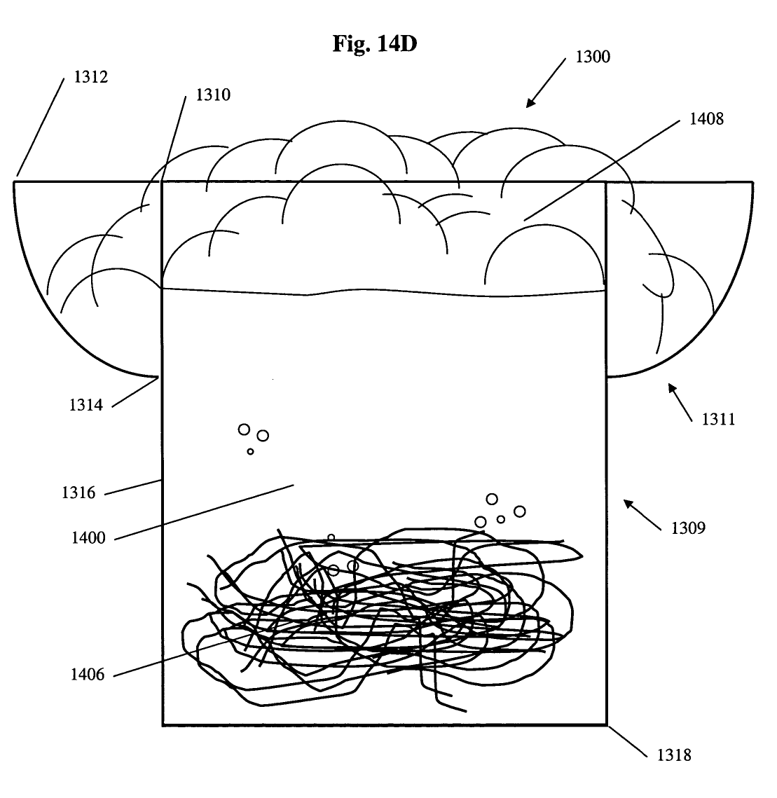

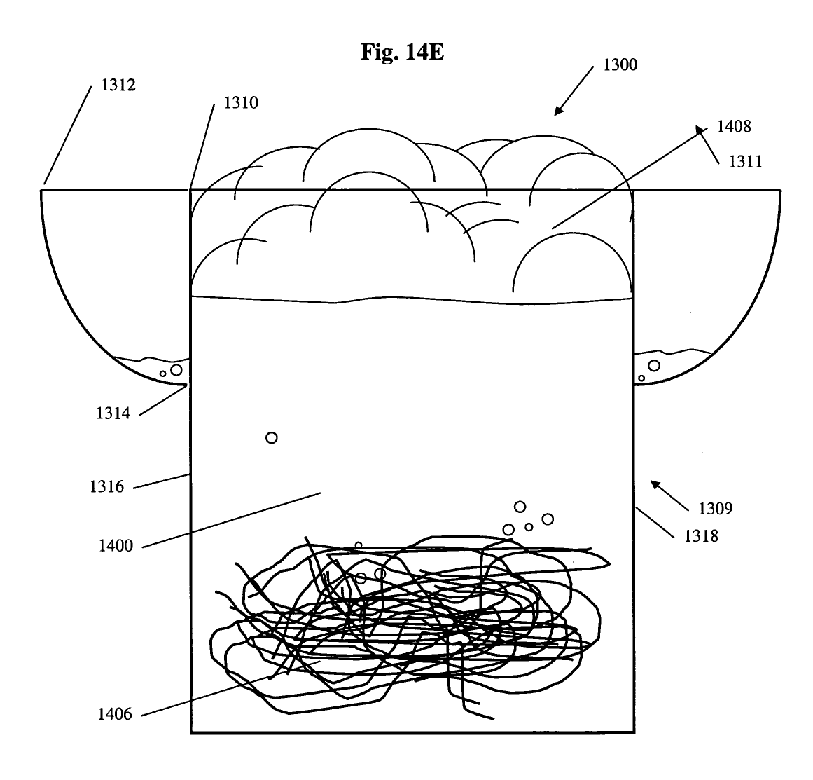

FIGS. 14A to 14D are cross-sectional views of the cooking container 1300 shown in FIG. 13. As shown in the figures, pasta 1406 can be cooked in the container 1300 by filling the container 1300 with water 1400 and heating the water 1400 by turning on the burner 1302. When the water 1400 comes to a boil, the pasta 1406 is added to the water 1400 as shown in FIG. 14B. Typically, as shown in FIG. 14C, when the pasta 1406 is boiled in the water 1400, foam 1408 is generated at the surface of the water 1400. As the water 1400 continues to be heated and the pasta 1406 continues to cook, the amount of foam 1408 increases, and some of the foam 1408 flows over the inner rim 1310 of the inner container 1309 and into the outer container 1311 as shown in FIG. 14D.

When the foam 1408 flows into the outer container 1311, it is somewhat removed from the heated water 1400 and the other heat created by the burner 1302 and begins to cool. When the foam 1408 in the outer container 1311 cools, it condenses into a liquid state as shown in FIG. 14E.

Since the outer container 1311 is provided around the inner container 1309, the foam 1408 that flows over the inner rim 1310 is prevented from traveling all of the way down the outer side surface 1316 of the inner container 1309. As a result, the overflowing foam 1408 does not contact the burner 1302 of the stove 1304 and cause the problems described above.

As shown in FIGS. 13 and 14A to 14E, the inner rim 1310 of the inner container 1309 and the outer rim 1312 of the outer container 1311 are at the same height and lie within the same plane. Also, the bottom edge 1314 of the outer container 1311 is connected to the side surface 1316 of the inner container 1309 at a point between the inner rim 1310 and the bottom edge 1318 of the inner container 1309. However, the present invention is clearly not limited to such an arrangement and can have many different structures and arrangements as discussed above.

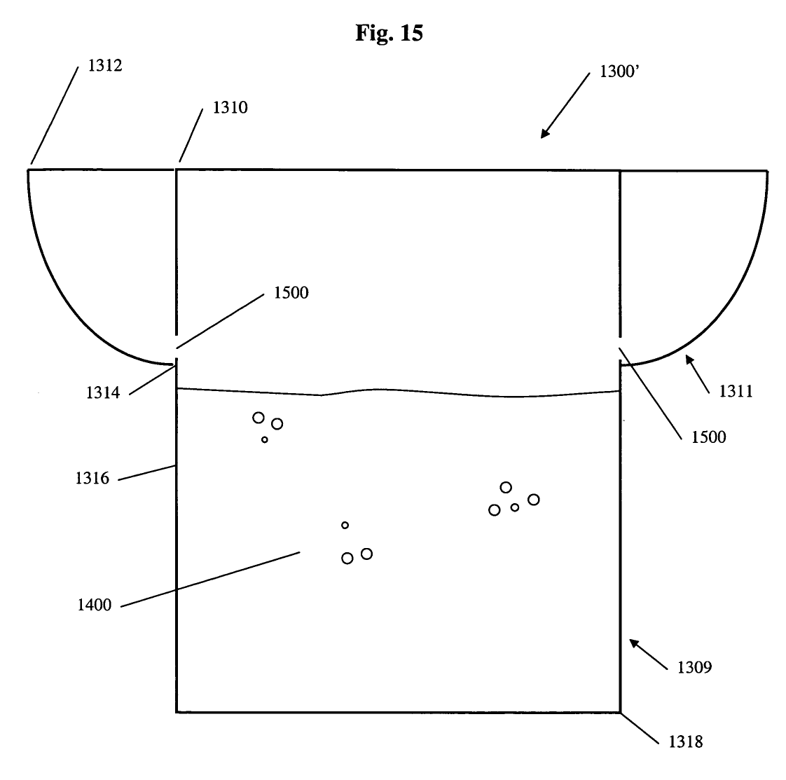

FIG. 15 shows a cross-sectional view of a non-limiting embodiment of a cooking container 1300′, which is similar to the container 1300 shown in FIG. 13. However, unlike the container 1300, the container 1300′ comprises an inner container 1309 that has one or more holes 1500. The hole or holes 1500 provide a fluid path from the interior of the outer container 1311 to the interior of the inner container 1309 in a manner that is similar to the manner discussed above in conjunction with the container 600′ shown in FIGS. 11A to 11C.

When the container 1300′ shown in FIG. 15 is used to cook pasta 1406, foam 1408 is created on the surface of the water 1400 and typically flows into in the outer container 1309 as described above. However, when the foam in the outer container 1309 cools and condenses into a liquid, the liquid flows back into the inner container 1309 via the hole or holes 1500. As a result, the amount of condensed liquid that collects in the outer container 1311 is significantly reduced. Thus, the probability that the foam 1408 will flow over the outer rim 1312 of the outer container 1311 towards the burner 1302 decreases.

Also, as described above in conjunction with the embodiment shown in FIGS. 11A to 11C, the hole or holes 1500 clearly can be used with many types of containers 1309 and 1311 besides the specific containers 1309 and 1311 illustrated in FIG. 15. For example, the hole or holes 1500 may be used with virtually any shaped containers 1309 and 1311 and may be located at numerous positions on the inner container 1309, as long as a fluid path is provided between the interiors of the containers 1309 and 1311.

Also, as described above in conjunction with FIG. 11D, one or more valves (not shown) may be provided with the hole or holes 1500. Moreover, virtually any type of valve can be used that allows the water 1400, foam 1408, and/or the liquid to flow from the outer container 1311 to the inner container 1309 and that prevents or at least retards the flow of water 1400, foam 1408, and/or the liquid from the inner container 1309 to the outer container 1311.

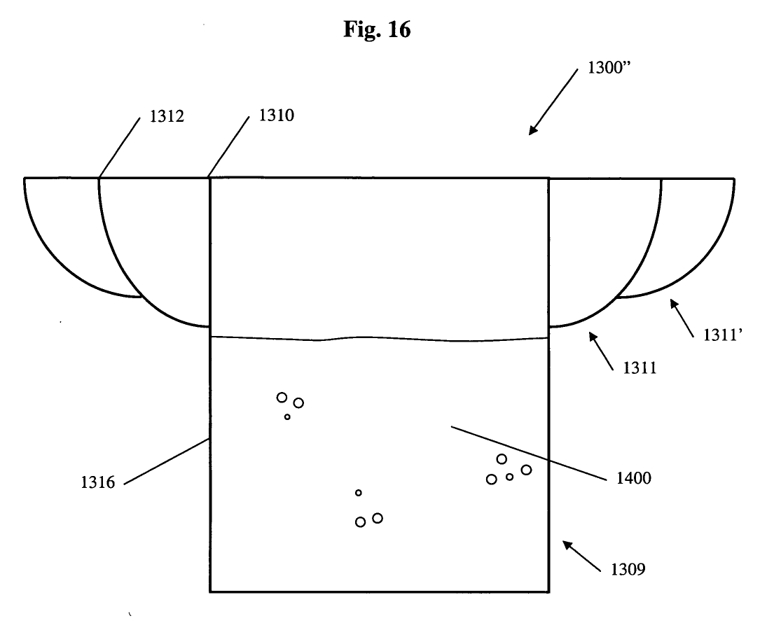

In addition, although the embodiments described above have an inner container 1309 and only one outer container 1311, the present invention is not limited to such a configuration. For example, FIG. 16 shows an illustrative, non-limiting embodiment of a container 1300″ that contains a first outer container 1311 and a second outer container 1311′. By using the second outer container 1311′, the possibility of foam 1408 traveling all of the way down the outer side surface 1316 of the inner container 1309 is further reduced for reasons that are similar to those presented above in conjunction with the container 600″ shown in FIG. 12.

Furthermore, like the container 600″ shown in Fig, 12, a non-limiting embodiment of the invention may employ more than two outer containers. In addition, specific structures and shapes of the containers 1309, 1311, and 1311′ are not limited to those shown in FIG. 16, and many differently shaped containers 1309, 1311, and 1311′ can be used. Also, as described above in conjunction with FIG. 12, a hole or holes (not shown) may be provided between the interiors of the inner container 1309 and the first outer container 1311 and may be provided between the interiors of the first outer container 1311 and the second outer container 1311′.

The previous description of the preferred embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty.

For example, some or all of the features of the different embodiments discussed above may be combined into a single embodiment. Conversely, some of the features of a single embodiment discussed above may be deleted from the embodiment.

In addition, the above embodiments are described in the context of cooking containers. However, the present invention may be applied to other containers that are not used for cooking.

Therefore, the present invention is not intended to be limited to the embodiments described herein but is to be accorded the widest scope as defined by the limitations of the claims and equivalents thereof.

1. A container apparatus, comprising:
an inner container, which has a first upper edge and which holds a substance in a first space inside the inner container; and
an outer container coupled to the inner container,
wherein a second space is defined between the inner container and the outer container, and
wherein, when the substance flows out of the first space inside the inner container and over the first upper edge, the substance is received in the second space.

2. The apparatus as claimed in claim 1, wherein an edge of the outer container is attached to an outer surface of the inner container and is attached between the first upper edge of the inner container and a bottom edge of the inner container.

3. The apparatus as claimed in claim 2, wherein the edge of the outer container is a bottom edge of the outer container.

4. The apparatus as claimed in claim 1, wherein an edge of the outer container is attached to a bottom edge of the inner container.

5. The apparatus as claimed in claim 4, wherein the edge of the outer container is a bottom edge of the outer container.

6. The apparatus as claimed in claim 1, wherein the first space is defined by at least an inner surface of the inner container, and
wherein the second space is defined between an outer surface of the inner container and an inner surface of the outer container completely surrounds the first space.

7. The apparatus as claimed in claim 1, wherein the outer container comprises a second upper edge, and
wherein the second upper edge completely surrounds the first upper edge of the inner container.

8. The apparatus as claimed in claim 6, wherein the outer container comprises a second upper edge, and
wherein the second upper edge completely surrounds the first upper edge of the inner container.

9. The apparatus as claimed in claim 7, wherein a shape of the first upper edge, when viewed from above, and a shape of the second upper edge, when viewed from above, are substantially the same.

10. The apparatus as claimed in claim 7, wherein a shape of the first upper edge, when viewed from above, and a shape of the second upper edge, when viewed from above, are substantially different.

11. The apparatus as claimed in claim 9, wherein the shape of the first upper edge is substantially circular when viewed from above, and
wherein the shape of the second upper edge is substantially circular when viewed from above.

12. The apparatus as claimed in claim 1, wherein the inner container is substantially cylindrical, and
wherein the outer container is substantially bowl-shaped.

13. The apparatus as claimed in claim 1, wherein a central axis of the inner container is substantially collinear with a central axis of the outer container.

14. The apparatus as claimed in claim 12, wherein a central axis of the inner container is substantially collinear with a central axis of the outer container.

15. The apparatus as claimed in claim 7, wherein the first upper edge of the inner container and the second upper edge of the outer container are located at the same height.

16. The apparatus as claimed in claim 15, wherein the first upper edge of the inner container and the second upper edge of the outer container lie within the same plane.

17. The apparatus as claimed in claim 7, wherein the first upper edge of the inner container and the second upper edge of the outer container are located at different height.

18. The apparatus as claimed in claim 17, wherein the first upper edge is higher than the second upper edge.

19. The apparatus as claimed in claim 17, wherein the second upper edge is higher than the first upper edge.

20. The apparatus as claimed in claim 1, further comprising at least a first hole to provide a flow path from the second space to the first space.

21. The apparatus as claimed in claim 20, wherein the first hole is provided in an outer surface of the inner container.

22. The apparatus as claimed in claim 20, further comprising a first valve,
wherein the first valve allows the substance to flow from the second space, through the first hole, and into the first space, and
wherein the first valve at least impedes the substance from flowing from the first space, through the first hole, and into the second space.

23. The apparatus as claimed in claim 22, wherein the valve is located within the inner container and is pivotally attached to an inner surface of the inner container.

24. The apparatus as claimed in claim 23, wherein the valve is pivotally attached above the first hole.

25. The apparatus as claimed in claim 1, further comprising a second outer container coupled to the outer container,
wherein a third space is defined between the outer container and the second outer container,
wherein the outer container has a second upper edge, and
wherein, when the substance flows out of the outer container and over the second upper edge, the substance is held in the third space by the second outer container.

26. The apparatus as claimed in claim 1, wherein the outer container holds the substance such that the substance does not flow down an outer surface of the inner container and past a bottom edge of the inner container.

27. The apparatus as claimed in claim 1, wherein the substance comprises cooking oil.

28. The apparatus as claimed in claim 1, wherein the substance comprises at least one of foam and water.

29. The apparatus as claimed in claim 28, wherein the substance comprises both the foam and the water.

30. A container apparatus, comprising:
an inner container having a first upper edge; and
an outer container, which is coupled to the inner container and which has a second upper edge,
wherein the second upper edge completely surrounds the first upper edge of the inner container such that an interior of the outer container completely surrounds the interior of the inner container when viewed from above,
wherein, when a substance flows out of the inner container and over the first upper edge, the substance is held in the outer container, and
wherein the outer container receives the substance such that the substance does not flow down an outer surface of the inner container and past a bottom edge of the inner container.

31. The apparatus as claimed in claim 30, wherein a bottom edge of the outer container is attached to the outer surface of the inner container and is attached between the first upper edge of the inner container and the bottom edge of the inner container.

32. The apparatus as claimed in claim 30, wherein a bottom edge of the outer container is attached to the bottom edge of the inner container.

33. The apparatus as claimed in claim 30, wherein a shape of the first upper edge is substantially circular when viewed from above, and
wherein a shape of the second upper edge is substantially circular when viewed from above.

34. The apparatus as claimed in claim 33, wherein the inner container is substantially cylindrical, and
wherein the outer container is substantially bowl-shaped.

35. The apparatus as claimed in claim 33, wherein the inner container is substantially cylindrical, and
wherein the outer container is substantially cylindrical.

36. The apparatus as claimed in claim 30, further comprising at least a first hole in the inner container to provide a flow path from the outer container to the inner container.

37. The apparatus as claimed in claim 36, further comprising a first valve,
wherein the first valve allows the substance to flow from the outer container, through the first hole, and into the inner container, and
wherein the first valve at least impedes the substance from flowing from the inner container, through the first hole, and into the outer container.

38. The apparatus as claimed in claim 30, wherein the apparatus is a cooking apparatus.

39. The apparatus as claimed in claim 1, wherein a bottom edge of the outer container is located below a bottom edge of the inner container.

40. The apparatus as claimed in claim 1, wherein the outer container is connected to the inner container via at least one support.

41. The apparatus as claimed in claim 39, wherein the outer container is connected to the inner container via at least one support.

42. The apparatus as claimed in claim 41, wherein the outer surface of the inner container comprises an outer side surface,
wherein the inner surface of the outer container comprises an inner side surface, and
wherein the inner side surface of the outer container is connected to the outer side surface of the inner container via the at least one support.

43. The apparatus as claimed in claim 42, wherein the at least one support comprises a plurality of supports.

44. The apparatus as claimed in claim 43, wherein the supports are arranged around the outer side surface of the inner container in a spoke-like fashion.

45. The apparatus as claimed in claim 44, wherein the supports are uniformly spaced around the outer side surface of the inner container.

46. The apparatus as claimed in claim 41, wherein the outer container is connected to an outer bottom surface of the inner container via the at least one support.

47. The apparatus as claimed in claim 46, wherein the outer container is connected to an outer bottom surface of the inner container via a plurality of supports.

48. The apparatus as claimed in claim 1, wherein the second space is defined between an outer surface of the inner container and an inner surface of the outer container.
